(19) United States
(12) Patent Application Publication
(10) Pub. No.: US 2005/0010533 A1
(43) Pub. Date: Jan. 13, 2005

(54) Data processing systems

(76) Inventor: Robert Cooper, Reigate (GB)

Correspondence Address: Nathan M Rau;Westman Champlin & Kelly, 900 Second Avenue South, Suite 1600 - International Centre, Minneapolis, MN, 55402-3319, US

(21) Appl. No.: 10/489,274

(22) PCT Filed: Sep. 16, 2002
(86) PCT No.: PCT/GB02/04194

(30) Foreign Application Priority Data
Sep. 14, 2001 (GB) 0122233.0

(51) Int. Cl. G06F 17/60; H04K 1/00

(52) U.S. Cl. 705/64

(57) ABSTRACT

A data processing system 1 and a method are disclosed for provision of rewards such as mobile telephone air time to customers. A transaction means 11 comprises a database 111 at the checkout which stores product data for a plurality of-products for purchase. A second database 112 stores offer data representing a value (monetary or otherwise) of an offer relating to those products.

A till 113 receives information on the products purchased and forwards it to a first data processor 114 where a total cost is calculated. This is combined with data from the database 112 at a second data processor 115 to produce a total offer amount. This is concatenated or otherwise combined with a live code 120 to produce an encrypted rebate code 119 that includes a representation of the rebate amount. This is printed onto a till receipt 118.

A mobile telephone user sends the printed rebate code to an operator 211 at a clearing house location 21. Once the rebate code 119 is validated, the user's mobile telephone account may be credited with airtime in accordance with the value as included within the rebate code 119.

### FIELD OF THE INVENTION

This invention relates to data processing systems and is concerned particularly, although not exclusively, with data processing systems for store checkouts.

### BACKGROUND OF THE INVENTION

Customer reward and promotion schemes have been known for many years. In one of the best known systems, printed coupons are distributed to consumers, encouraging them to buy certain products, in return for which the coupon can be redeemed as a cash discount against the product that is purchased. Variations on this include store loyalty schemes, where customers are rewarded with discounts in return for making a certain level of purchases at a given store, or for making purchases of particular items at a particular store.

Traditionally, such reward and promotion schemes have operated most widely with printed coupons. Although doubtlessly successful, these schemes involve a considerable amount of time and expense in redeeming the coupons, which, even these days, requires a considerable amount of manual intervention.

Schemes have been proposed for automating loyalty reward and promoting schemes to a greater or less degree. The most common is to provide “reward points” to a customer's account when a purchase is made, in dependence upon the value of the purchase. One example of such a scheme is that disclosed in EP-A-0,929,874, which relates to a reward scheme, for awarding points to a customer on receipt of a valid code from the customer. The code is provided either on the packaging of a product to be purchased, or on the receipt for the purchased product. This code, along with additional information, is stored in a remote reference memory before it is provided to the customer. When the customer transmits the code to a data collection station, the code is recognized as being valid only if it has already been stored in the reference memory, at which point a predetermined number of points is awarded. In this way, information and purchasing habits of the customer may be collected and stored. However, a problem associated with such schemes is that the customer still then has to go through a number of steps to redeem the reward points that progressively accumulate.

Preferred embodiments of the present invention aim to provide improved data processing systems that can be used to implement store and product reward and promotion schemes, in a more efficient and automated manner, especially as regards the redemption of rewards earned.

### SUMMARY OF THE INVENTION

According to a first aspect of the present invention, there is provided a data processing system for a checkout rebate scheme, comprising: a) transaction means, having: checkout memory means arranged to store data relating to a plurality of products for purchase, the data including offer data, if any, for each product; checkout processing means arranged to identify ones of the plurality of products and quantities thereof and to calculate a rebate total from the identified product quantities and offer data; and receipt generation means, arranged to generate a receipt; b) encryption means arranged to encrypt the rebate total to produce encrypted data in the form of a rebate code, the receipt generation means being further arranged such that the generated receipt indicates the rebate code; c) validation and decryption means arranged to receive a code, to determine that the code is a valid rebate code, and to decrypt the code, when it has been determined as a valid rebate code, so as to reveal the rebate total; and d) rebate application means arranged to receive the rebate total and to authorize the rebate.

According to a further aspect of the invention, there is provided a data processing method for a checkout rebate scheme, comprising the steps of: a) identifying ones of products from a plurality of products for purchase stored in checkout memory means; b) identifying quantities and offer data of the identified products; c) calculating a rebate total from the identified quantities and offer data; d) encrypting the rebate total using encryption means to produce encrypted data in the form of a rebate code; e) generating a receipt using receipt generation means and indicating the rebate code on the generated receipt; f) issuing the generated receipt to a customer; g) receiving at validation and decryption means a code from a sender; h) determining that the code is a valid rebate code and decrypting the code to reveal the rebate total using the validation and decryption means; and i) receiving the rebate total at rebate application means and authorising the rebate.

Providing a data processing system in which the only information required to be processed in order to perform the rebate procedure is the rebate total, results in a highly efficient system, which is quick and simple to use. This is especially so in embodiments in which a mobile telephone is used to communicate the rebate code to the encryption means, since the system allows the time taken by the customer to input the rebate code to be advantageously reduced.

In addition, by providing an encryption means which is arranged to encrypt the rebate total, a highly secure data processing system may be achieved, advantageously reducing the possibility of abusing a rebate scheme.

### BRIEF DESCRIPTION OF THE DRAWINAS

For a better understanding of the invention, and to show how embodiments of the same may be carried into effect, reference will now be made, by way of example, to the accompanying diagrammatic drawings, in which:

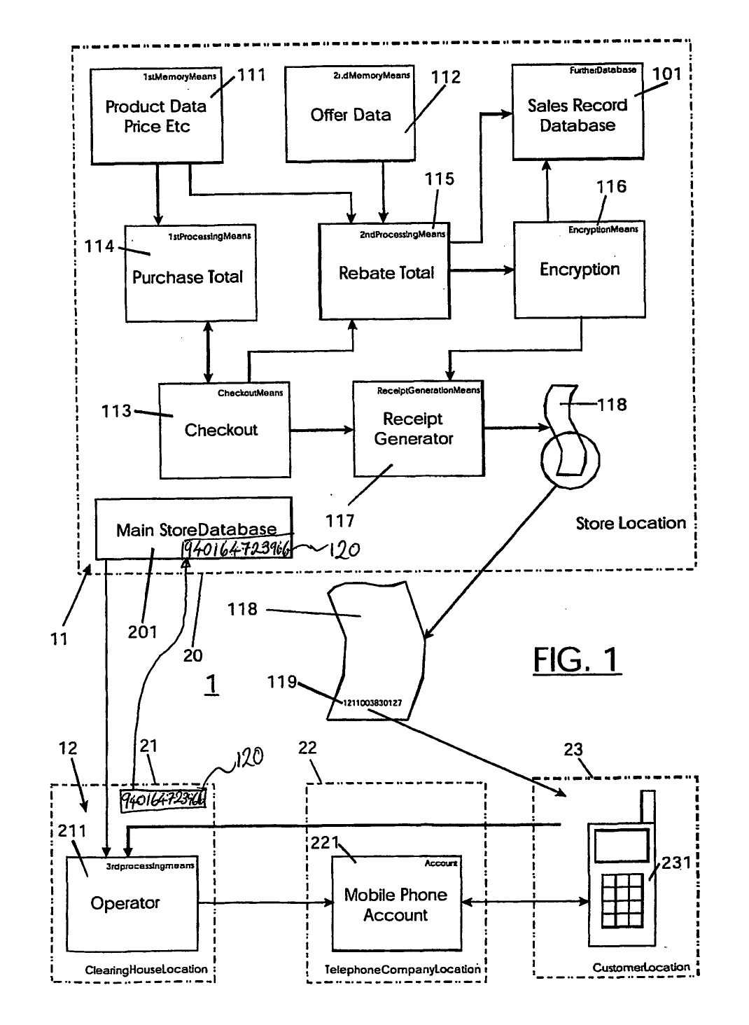

FIG. 1 illustrates a checkout data processing system, used in conjunction with a mobile telephone system;

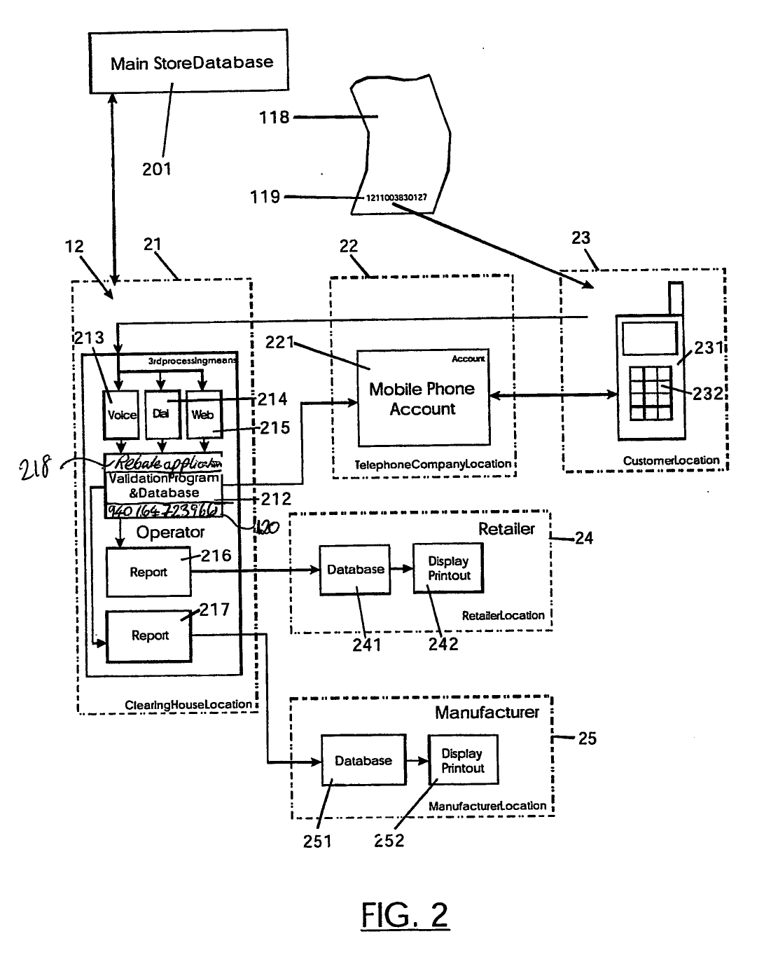

FIG. 2 illustrates parts of the data processing system that are concerned in particular with redemption of accrued loyalty credits;

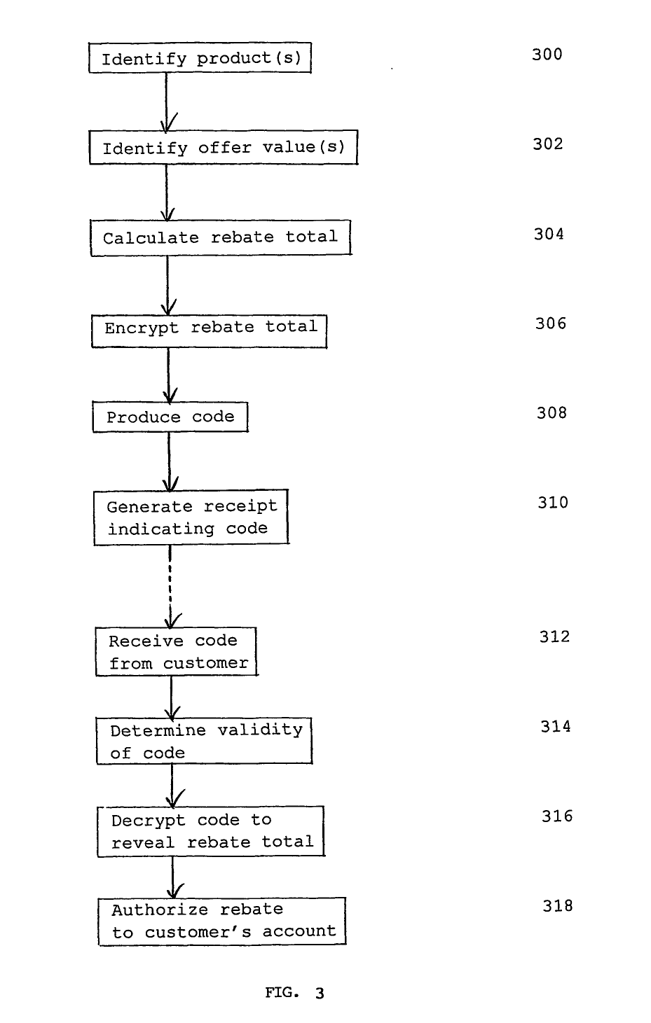

FIG. 3; illustrates a flow chart representing a method which embodies the present invention; and

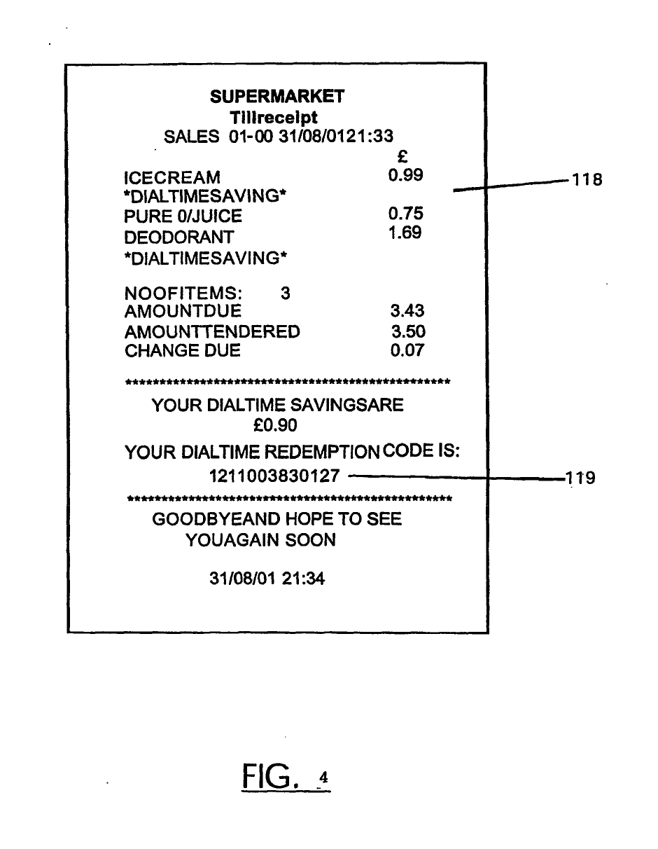

FIG. 4 illustrates a simple example of a printed receipt.

### DETAILED DESCRIPTION OF A PREFERRED EMBODIMENT

The illustrated checkout data processing system 1 comprising a first part 11 that is disposed in a store location 20 and a second part 12 that is located in a different, remote, clearing house location 21. The data processing system 1 co-operates in this example with a further, different remote location 22 of a telephone company and a yet further different, remote location 23 of a customer's mobile telephone.

In the following description, it will be apparent that the illustrated system is intended to co-operate with a large plurality of mobile telephones, the location 23 of each of which will be variable. However, for the ease of explanation, the present description is given with reference to just a single mobile telephone in a single customer location 23.

With reference to FIG. 2, the illustrated data processing system in this example is arranged to co-operate with two further, different, remote locations—a retailer location 24 (which may or may not be the same as the store location 20) and a manufacturer's location 25.

The first part 11 of the data processing system 1 comprises a first memory means in the form of a first database 111 that stores product data of a plurality of products for purchase. The product data includes a price for each of the products.

A second memory means in the form of a second database 112 stores, for at least some of the products listed in the first database 111, offer data that represents an offer value for each such product.

Referring to step 300 of FIG. 3, a checkout means in the form of a till 113 is arranged to receive input data representing quantities of products to be purchased and payment data representing payment for those products. It may incorporate barcode scanner, credit card reader, etc., as many modern tills do. It is connected to a main store database (not shown).

A first processing means in the form of a first data processor 114 receives input data from the till 113 and product data from the first database 111. From this data, the first data processor 114 calculates the total sum due for payment of the products to be purchased.

In step 302 of FIG. 3, a second processing means in the form of a second data processor 115 also receives data from the till 113, together with product data from the first database 111 and offer data from the second database 112. The second data processor 115 calculates from all of this data a rebate total representing the total of all offer values of the products to be purchased, as shown in step 304. This rebate total may be calculated on the basis of a number of individual products each having an offer value associated with it. Alternatively, the rebate total may be at least partly calculated on the basis of a single offer value which is made available only when a predetermined selection of products is bought together. Alternatively still, the rebate total may be at least partly calculated on the basis of an ‘instant win’ or lottery style promotion.

In steps 306 and 308, an encryption device 116 receives the rebate total from the second data processor 115 and generates therefrom encrypted data that represents the rebate total in coded form. The encryption device 116 passes the encrypted data to a receipt generator 117, which is also arranged to receive from the till 113 quantities, process and brief descriptions of all products to be purchased, together with the total sum due for payment and the amount of payment made. From all of this data, in step 310, the receipt generator 117 generates a printed receipt 118, a simplified example of which is shown in FIG. 4.

Steps 300 to 310 of FIG. 4 represent the procedure followed at the store location 20, up to the stage at which the receipt 118 is printed.

A customer having made purchases at the store location 20 receives the receipt 118, with all of the usual checkout information on it, but including a numeric or alphanumeric rebate code 119 which is the encrypted data representing the rebate total earned by the customer in the recent purchase. The rebate code 119 is indecipherable without the encryption algorithm, to which the customer and the world at large has no access.

For the avoidance of doubt, the term “encrypted data” or “coded data” (and like terms) in the context of this specification means data representing information that cannot be recognised from the encrypted or coded data without decryption or decoding of the data.

Being able to provide a secure rebate code 119 to a customer is an important consideration for ensuring the integrity of a rebate system. It is particularly desirable to produce a rebate code 119 which is sufficiently secure that abuse of the system is reduced, or prevented completely. This is especially so with the system embodying the present invention, in which it is desirable to minimise the amount of information contained within the rebate code 119 to improve handling and throughput. It will be understood that, as the amount of information stored in a code is reduced—resulting in an increasingly shortened code—it becomes less difficult for a potential misuser of the system to guess or otherwise calculate a code which is, in fact, valid.

Therefore, in one embodiment of the present invention, the rebate code 119 which is supplied to a customer is made secure in the following way. A set of live or ‘sparse’ codes 120 is generated. By way of example only, the live codes 120 are shown in FIGS. 1 and 2 as being generated at the clearing house location 21. However, it is to be understood that these live codes can equally be generated at the manufacturer's location 25, the retailer location 24, the store location 20, or elsewhere. Each generated live code 120 is arranged to be unique, with production thereof being based on cryptographic techniques for the secure generation of random numbers, as are well known in the art. These generated live codes 120 are of a predetermined length and structure, such that they may be subsequently used for determining the validity of a sender code received from a sender. For example, each live code 120 may contain 12 characters, in base 10 format—that is, using any of the numbers 0 to 9—arranged in a particular order which may partly include a fixed sequence of selected characters, or arranged with specific numbers—check digits—at predetermined locations within the code. Each live code 120 is unique, at least within a given period of time, in order to ensure that the possibility of there existing two identical and genuine rebate codes 119 is negligible.

Of course, the live codes 120 may alternatively contain more than 12 characters, or, in certain circumstances, fewer than 12 characters. For example, if the live codes 120 are generated at a location remote from the store location 20, that is, at a time prior to a transaction, it is possible to decrease the length of the live codes 120 to 8 characters, with no significant reduction in the security of the system.

Once the live codes 120 have been generated, they are issued, typically in batches, to the store location 20, either directly, or indirectly via the retailer location 24. At the same time, these live codes 120 are stored in a validation program and database 212, at the clearing house location 21, ready to be used for the subsequent validation procedure. The live codes 120 stored at the validation program and database 212 of the clearing house location 21, and the main store database 201 of the store location 20, are shown in FIGS. 1 and 2.

During a transaction at store location 20, the rebate total is calculated in the manner described above and may be represented by four base-10 characters. At that stage, one of the live codes 120, from the batch supplied to the main store database 201 at the store location 20, is received by the encryption device 116, along with the rebate total. The encryption device 116 combines the rebate total and the live code 120, to form a 16-character long data string. The resulting string consists of a first part which contains no specific information, serving instead as an identifier and a validation tool, and a second part which contains the rebate total in readable form. One or more check digits may then be added to the string, which is then obfuscated, in order to obscure the intelligibility of the formats of the live code and the rebate total. This is performed in a two-stage process, the order of which is not important: firstly, the base-10 data string is converted into a base-12 data string, using any of the numbers 0 to 9, as before, and the ‘#’ and ‘*’ symbols; and secondly, the order of the resulting string is rearranged in any suitable manner. The two symbols ‘#’ and ‘*’ are found on digital cellular telephones and modern fixed line telephones. The advantage of using the ‘#’ and ‘*’ symbols is that they may be given any predetermined and publicly-unknown values. Finally, one or more additional check digits may be added to the obfuscated data string, in order to increase security further.

This final, resulting rebate code 119 is that which is printed onto the till receipt 118 and supplied to the customer. Redemption of the value of the rebate total from the receipt 118 is very simple for the customer.

Typically using the mobile phone 231 at the customer location 23, the customer contacts an operator 211 at the clearing house location 21. Optional ways of doing this are discussed subsequently with reference to FIG. 2. However, in the present simple description, the customer at location 23 communicates to the operator 211 the coded data 119 printed onto the receipt 118, as shown in step 312 of FIG. 3. The coded data 119 is checked by the operator 211 as being a valid code, and decrypted to indicate the redemption value, in steps 314 and 316 respectively.

For this purpose, the operator employs a validation program and database 212. The validity of a rebate code 119, which has been received at the clearing house 21 from a sender, is determined generally by reversing the concealment procedure performed at the store location 20. Therefore, the rebate code 119 is re-ordered and then converted back into base-10 format, or vice versa, depending on which way round this was performed originally. This process reveals the original ID code, or live code 120, and the original rebate total. A received rebate code 119 is recognised as being valid if the live code 120 is one which has been genuinely issued to a store location 20; that is, the validity of the received rebate code 119 depends on whether the live code 120 has been stored in the validation program and database 212. Of course, other additional validity checks may be performed on the rebate code 119, such as verifying that a check digit is correct, or that the code is syntactically valid.

If a received rebate code 119 is deemed to be valid, following the above procedure, the rebate total embedded in it is sent to and received by rebate application means 218 (FIG. 2), which may or may not form part of the validation program and database 212. In step 318 of FIG. 3, using the rebate application means 218, the operator 211 communicates to a respective mobile phone account 221, at the telephone company location 22, details of the customer's mobile telephone number 231 and the amount of the rebate total that was embedded in the rebate code 119. One particular advantage of the present invention is that this is all the information about a customer which is actually necessary for the system to be able to operate effectively. The telephone company immediately converts the rebate total into a credit on the mobile phone account 221, which, in effect, gives the customer a certain amount of pre-paid airtime for the mobile telephone 231.

In this way, the customer can be rewarded very quickly for the purchase represented on the receipt 118, in a very attractive manner that represents “free airtime” on the customer's mobile telephone 231.

It will be understood that the rebate total need not of course be “airtime”; cash or other currency may instead be provided, or credit, or any other form of rebate or reward. Likewise, a mobile telephone is described for the sake of convenience, although other forms of telecommunication are equally feasible (in particular Internet or fixed line telephones, for example).

Steps 312 to 318 of FIG. 3 represent the procedure followed at the clearing house location 21, up to the stage at which the rebate is authorised.

In a further embodiment of the present invention, the encryption procedure of step 306 in FIG. 3 includes an additional, substantially unbreakable security feature. Following the calculation of the rebate total in step 304, a live code 120 is received by the encryption device 116, as described above. However, instead of merely embedding the rebate total in the code 120 in what is essentially a plain text format, the rebate total is itself encrypted, using a one-time pad. The encrypted rebate total is then added to the live, identifier, code 120 as before and the resulting data string is finally obfuscated, producing a rebate code 119 which may be supplied to a customer.

A one-time pad is any known sequence of characters, of the same length and in the same base as a portion of data which is to be encrypted. Each character in the one-time pad is equally likely to take any of the available values. Each character in the one-time pad is combined with its respective character in the data portion, producing an encrypted data string which may only be decrypted using the specific one-time pad used to encrypt it.

Two examples of how a one-time pad works will now be described:

1) A ten-digit binary message, such as 1011100101, is encrypted using the following one-time pad: 1110110011. Each respective pair of digits is combined using the XOR logical operation:

| | |
|---|---|
| Binary message | 1011100101 |
| One-time pad | 1110110011 |
| Encrypted string | 0101010110 |

As will be understood, the encrypted binary string may only be decrypted using the above one-time pad. Since there is an equal chance that a character in the pad takes the value 1 or 0, the probability of guessing the pad correctly is 1 in 2¹⁰.

2) A four-digit base-10 message, such as 3745, is encrypted using the following one-time pad: 2859. Each respective pair of digits is added together, mod 10:

| | |
|---|---|
| Base-10 message | 3745 |
| One-time pad | 2859 |
| Encrypted string | 5594 |

Since there is an equal chance that a character in the pad takes any of the values 0 to 9, there is an equal chance of the encrypted string taking any of the 9999 (or 10,000, if 0000 is a permitted pad) possible values. The probability of guessing the pad correctly therefore is 1 in 10⁴.

In this embodiment, each one-time pad—four digits long and in base-10 format—is generated and then associated with a single live code 120 at the live code generation stage described above. The pads are next sent, with the live code batches, to the validation program and database 212, ready for the subsequent decryption procedure. It is preferable for each price pad to be unique within a given period of time, although this may not necessarily be so.

On receipt of a rebate code 119 from a sender (step 312), the validation program and database 212 performs the reverse obfuscation procedure described above, to reveal a live code 120 and an encrypted rebate total. The transmitted rebate code 119 is recognised as being valid if the live code 120 is stored in the validation database 212 (step 314). At this stage, the pad associated with the recognised live code 120 is retrieved and used to decrypt the encrypted rebate total, by subtracting the pad from the encrypted rebate total, mod 10. The original, plain text, rebate total is again produced (step 316).

The rebate total is then received by the rebate application means 218, as before. However, in this embodiment, the rebate is not immediately authorised. Instead, a simple rebate confirmation message is returned to the customer's mobile telephone, preferably by means of a SMS text message, confirming the value of the rebate and that the rebate will be applied to the account corresponding to the mobile telephone number, which is determined by calling line identification when the rebate code 119 is first received from the customer. This confirmation message does not result in the credit being applied to the appropriate account at that moment, since a further security measure must first be implemented. Of course, other techniques may instead be employed, such as a “ring back” procedure. This is particularly but not exclusively useful for fixed (land line) telephones which are not SMS enabled.

This measure consists of a store download of all transactions resulting in a rebate being made available to a customer. The rebate total which has been derived from the rebate code 119 received from a customer is reconciled against information received by the rebate application means 218 from the store location 20. This information may alternatively be sent from the retailer location 24. Typically, the information will include details of the store location 20, the purchase, the live code 120 and one-time pad which were used and the rebate total which was calculated. The customer-originating rebate total is reconciled against the store download information, by matching the customer-originating live code with one of the live codes downloaded from the store location 20.

This security procedure is known as a two-phase commit process and is known in the field of authorisation of credit card transactions and the like. Such downloads may take place every 24 hours, or more frequently if necessary.

Once the information received from the customer has been reconciled with that received from the store location 20, the rebate is actually approved. The rebate application means 218 sends an authorisation message to the customer's mobile or fixed telephone network provider, along with details of the rebate to be credited, at which point the credit is applied to the customer's account by the telephone company at location 22.

If an inconsistency is discovered at any of the security stages, either the rebate is immediately voided, or the customer may be given an opportunity to re-enter a code. For example, the reverse obfuscation process may reveal a character string which is not syntactically valid, or which contains an incorrect check digit; the live code 120 may not be recognised; or the store reconciliation may reveal that a purchase did not take place, or that the rebate total is incorrect. This embodiment of the present invention therefore provides a highly secure data processing system.

An alternative embodiment of the present invention includes means to generate the live codes 120 and the one-time price pads at the store location 20 or retailer location 24, but particularly at the point of sale. In this scheme, the live code 120 and pad are randomly generated at the stage when products are purchased, instead of being generated before purchase and sent to the store location 20 in batches. The generated live code 120 and price pad are then downloaded to the clearing house location 21 at the same time as the usual daily transaction information download previously described.

It will be understood that, while reducing the need to store live codes 120 and pads in batches before purchases are made and being highly secure, such a system does not immediately provide the clearing house location 21 with the capability of real-time feedback to a customer, since validation and decryption processes may not take place before a relevant store download.

One preferred option to overcome this is to arrange for the code produced in step 308 to include, along with any check digits, the live code 120, the pad-encrypted rebate total and the unencrypted, or plain text, rebate total, before the obfuscation stage. While this results in a rebate code 119 which is longer than those described above with reference to other embodiments, it allows a system, in which the rebate codes 119 are produced at the store location 20 and which is able to provide real-time feedback to customers, to operate in a highly secure manner. It will be understood that the rebate is authorised only if all of the information received at the clearing house location 21 matches.

It is envisaged that any combination of the above security measures be employed with the system of the present invention.

The operator 211 tracks all coded data 119 that has been redeemed for airtime credits (or other rewards), to ensure that each code—which is unique—is redeemed only once. In this respect, the encryption device 116 is arranged to encode the data in such a way that each item of encrypted data 119 that it outputs is a unique combination of characters.

FIG. 2 illustrates in further detail how the operator 211 may function at the clearing house location 21. Validation of the coded data 119 may be carried out entirely automatically or with human operator intervention.

To this end, the operator incorporates a decryption and validation program and database 212 that is arranged to receive the encoded data 119 in one of three optional ways. That is, by way of a voice module 213, a dial module 214 or a web module 215.

Using the voice module 213, the user may establish direct human contact with the operator 211, and simply speak the characters of the coded data 119, which the operator 211 then enters into the validation program and database 212. Upon validation, the mobile phone account 221 is credited accordingly, as previously described.

To semi-automate this process, the voice module 213 may, instead of utilising a human intermediary, incorporate a voice recognition system that is adapted to recognise numbers and/or letters spoken distinctly. Alternatively, the rebate code 119 may be transmitted using “touch tone” technology, i.e. Dual Tone Multi Frequency (DTMF). The data is then entered into the validation program and database 212 as before.

A more efficient way of entering the alphanumeric data may be via the dial module 214. As an example of this, the customer is invited to enter the coded data 119 via the keypad 232 of the mobile telephone 231. The coded data is then passed directly to the validation program and database 212, which operates as previously described. One particular advantage of the embodiments described above is that the rebate code 119 which is supplied to the customer is in base-12 format, using the characters 0-9, # and *. A mobile telephone (and indeed a modem attached to a land line) permits these characters to be entered quickly, by means of one-touch key presses, resulting in the possibility of transmitting the rebate code 119 quickly and simply. Moreover, the use of the * and # keys allows the rebate code 119 to employ a reduced number of digits (for example, a reduction by one digit).

If desired, the dial module 214 can incorporate CLI (calling line identification) recognition means, which recognises the number of the mobile telephone 231 that is making the call to the operator 211. If desired, such number recognition may be utilised to indicate to the operator 211 that the caller has a valid account with a mobile network.

As a variation of the above, the customer may input the encrypted data 119 to the operator 211 via an SMS text message that is sent, preferably free of charge, via the mobile telephone 231. Typically, the SMS text message will automatically include the telephone number of the mobile telephone 231 (via caller identification), thereby uniquely identifying the customer and the telephone account to be credited.

The third option shown in FIG. 2 involves use of the web module 215. Rather than use the mobile telephone 231 directly, the customer connects to the web module 215 over the Internet (or other such computer network), using a fixed Internet connection, WAP, 3G, or mobile access via a Personal Digital Assistant (PDA). The connection may be a direct connection over the Internet or by an e-mail that is sent by the customer and received by the web module 215. In either event, the web module 215 receives the coded data 119 that has been input by the customer and passes it to the validation program and database 212, which proceeds as previously described.

The operator 211 may provide additional reporting functions. All of the information that is embedded in the coded data 119 is held in the database 212, which may also include the totals of sums redeemed. Depending on the complexity of the coded data 119, it may even contain information as to particular products purchased in response to offer value promotions. This may apply in particular where, in a variant, there is indicated on the receipt, for each product on offer, or selected products on offer, a respective, individual encrypted data code that can be redeemed via the operator.

Thus, a first reporting device 216 can receive information from the database 212, analyse it, and send corresponding report data to a database 241 at the retailer location 24 where, optionally, it may be displayed or printed out via a display and/or printout device 242. The report data may be transmitted via a permanent connection, or by periodic batch report, initiated by the operator 211 or a dial-up request from the retailer location 24. As indicated above, the retailer location 24 may be the same as or separate to the store location 20. Particularly, where a retailer has a chain of stores, it may be at a headquarters location of the retailer and therefore at a different location to the store location 20.

As described above, the retailer also sends reports to the operator 211, as to the number and value of codes 119 printed on receipts, for recompense by the operator 211 on behalf of the respective manufacturer(s).

Likewise, a second reporting device 217 may receive information from the database 212 and subsequently generate and transmit report data to a database 251 at manufacturer's location 25, where the report data may be displayed and/or printed out via suitable device 252.

It is to be appreciated that the illustrated data processing system is only one particular example. Various modifications may be made to it and alternative embodiments may be provided.

For example, the second database 112 is shown as being located in the store location 20. Alternatively, it could be located at the clearing house location 21, with a realtime data link between the store location 20 and clearing house location 21. Also, as indicated above, a real-time link may be provided between the store location 20 and clearing house location 21, in order to keep the operator 211 updated on a realtime basis as to all transactions carried out at the store location 20, for cross-checking with the information derived from the coded data 119, as part of the validation procedure. To this end, the operator 211 will have at least a degree of access to the main database 201 at the store location 20.

The encryption device 116 is typically located at the store location 20, or a retailer's headquarters location such as 24, but alternatively may be located at the clearing house location 21, with a real-time link to the store location 20.

In such an arrangement, a daily (or other periodic) batch download of data may be carried out from the operator 211 to the first and second databases 111, 112, to indicate the products currently on offer and the respective offer values. For example, for each product on offer, the first database 111 may have a flag set, to cause the second database 112 and second data processor 115 to be brought into play, to calculate offer values.

The second data processor 115 and/or encryption device 116 may be arranged to maintain a further database 101 of all products on offer that have been purchased, either directly or via further data processing means. Reporting means may then interrogate the further database 101 to produce various reports, as to identities and quantities of products on offer that have been purchased, over a desired time period or summarised by any desired headings. Such reports may be sent to the operator 211 at periodic intervals, or in response to dial-up requests from the operator 211.

The clearing house location 21 is shown as being remote from the store location 20, and it is envisaged that this will be very much the most likely arrangement. However, the store location 20 and clearing house location 21 could be coincident. The same goes for the telephone company location 22.

Although the illustrated example indicates redemption of rebate totals against airtime for a mobile telephone 231, it could also apply to credits to a telephone account for fixed telephone service, or indeed to any other form of “reward” such as cash. In the illustrated example, the mobile telephone 231 is used to communicate with the operator 211. However, a fixed telephone link or a link through any other medium may alternatively be utilised.

Although the illustrated examples show redemption of rebate totals against a credit account, redemption could alternatively be for any other services or goods.

As indicated in FIG. 3, the receipt gives an indication against each purchased product that has an offer value—referred to here as “Dialtime Saving”. The system may be arranged to print the individual offer value adjacent each respective item, either in monetary or airtime values, or as encrypted data.

In order to provide reports to the retailer and manufacturer locations 24, 25, the operator 211 may have access to the main database 201 at the store location 20, as indicated above. Thus, the encoded data 119 need indicate only a particular transaction at the store, whereafter the operator 211 can download from the main store database all further data relating to that transaction, from which the first and second reporting devices 216, 217 can prepare and forward reports to the retailer and manufacturer locations 24, 25. Alternatively, as indicated above, the operator 211 may have access to the further database 101 that stores data as to all products on offer that have been purchased, from which data the operator may produce reports as desired.

Although various components of the data processing system are shown separately, two or more of them may be combined in or provided by a single device. For example, the first and second databases 111, 112 may be provided in a common memory device.

1. A data processing system for a checkout rebate scheme, comprising:
a) transaction means, having:
checkout memory means arranged to store data relating to a plurality of products for purchase, the data including offer data, if any, for each product;
checkout processing means arranged to identify ones of the plurality of products and quantities thereof and to calculate a rebate total from the identified product quantities and offer data; and
receipt generation means, arranged to generate a receipt;
b) encryption means arranged to encrypt the rebate total to produce encrypted data in the form of a rebate code, the receipt generation means being further arranged such that the generated receipt indicates the rebate code;
c) validation and decryption means arranged to receive a code, to determine that the code is a valid rebate code, and to decrypt the code, when it has been determined as a valid rebate code, so as to reveal the rebate total; and
d) rebate application means arranged to receive the rebate total and to authorize the rebate.

2. The system of claim 1, wherein the rebate application means authorizes the rebate by transmitting a credit message, including an identification of an account of a customer to be credited and the rebate total, to a provider of the customer's account.

3. The system of claim 1, wherein the rebate total has a value representative of a reward selected from the list comprising airtime on a mobile (cellular) telephone account, a rebate against a fixed (land line) telephone account, and cash.

4. The system of claim 1, wherein the validation and decryption means and the rebate application means are at a different location from the checkout means and the encryption means.

5. The system of claim 1, wherein the validation and decryption means is arranged to receive the code via either a telephone link, a mobile telephone link, or a computer network link, the code being entered by a sender via a numeric or alphanumeric keypad.

6. The system of claim 1, wherein the receipt generation means is further arranged such that the generated receipt indicates the rebate total, as well as the rebate code.

7. The system of claim 1, wherein the receipt generation means is further arranged such that the generated receipt indicates a rebate code and optionally, a rebate total as well, for each of the identified products having an offer value greater than zero.

8. The system ofclaim 1, further comprising identifier code generation means arranged to generate an identifier code prior to a customer purchase, the generated identifier code being stored in both the checkout memory means and the validation and decryption means.

9. The system of any one of claim 1, wherein the transaction means is arranged to generate an identifier code at a time of purchase and to transmit the identifier code to the validation and decryption means.

10. The system of claim 8, wherein the encryption means is arranged to generate the rebate code on the basis of at least the identifier code and the rebate total.

11. The system of claim 8, wherein the means for generating the identifier code is further arranged to generate a price pad associated with the identifier code, the price pad being stored at the same times as the identifier code, the encryption means being further arranged to use the price pad to encrypt the rebate total and the validation and decryption means being further arranged to use the price pad to decrypt the second code.

12. The system of claim 11, wherein the price pad is formed of a first number of characters in a first base format, the first number and first base format being identical to a second number and a second base format of the rebate total, wherein the encryption means is arranged to encrypt the rebate total by operating on characters of the rebate total with respective characters of the price pad in a predetermined manner.

13. The system of claim 8, wherein the rebate application means is arranged to authorise the rebate only if i) the received code is syntactically valid, ii) the live code is recognised by the validation and decryption means, and iii) the rebate total derived from the received code is reconciled with reconciliation information subsequently received by the validation and decryption means.

14. The system ofclaim 9, wherein the encryption means is arranged to generate the rebate code on the basis of at least the identifier code and the rebate total.

15. The system of claim 1, wherein the receipt indicating the rebate code is received by a customer, the validation and decryption means being further arranged to receive the rebate code from the customer.

16. A data processing method for a checkout rebate scheme, comprising the steps of:
a) identifying ones of products from a plurality of products for purchase stored in checkout memory means;
b) identifying quantities and offer data of the identified products;
c) calculating a rebate total from the identified quantities and offer data;
d) encrypting the rebate total using encryption means to produce encrypted data in the form of a rebate code;
e) generating a receipt using receipt generation means and indicating the rebate code on the generated receipt;
f) issuing the generated receipt to a customer;
g) receiving at validation and decryption means a code from a sender;
h) determining that the code is a valid rebate code and decrypting the code to reveal the rebate total using the validation and decryption means; and
i) receiving the rebate total at rebate application means and authorising the rebate.

17. The method of claim 16 wherein the step of authorising the rebate includes transmitting a credit message, including an identification of an account of a customer to be credited and the rebate total, to a provider of the customer=s account.

18. The method of claim 16, wherein an identifier code is generated prior to a customer purchase and stored in both the checkout memory means and the validation and decryption means.

19. The method of claim 16, wherein an identifier code is generated at a time of purchase and is subsequently transmitted to the validation and decryption means.

20. The method of claim 18, in which the encryption means generate the rebate code on the basis of at least the identifier code and the rebate total.

21. The method of claim 18, wherein a price pad associated with the identifier code is generated and stored at the same times as the identifier code and the price pad is used to encrypt the rebate total and subsequently to decrypt the received code.

22. The method of claim 18, wherein the rebate is authorised only if i) the received code is syntactically valid, ii) the identifier code is recognised by the validation and decryption means, and iii) the rebate total derived from the received code is reconciled with reconciliation information subsequently received by the validation and decryption means.

23. The method of claim 16, wherein the encryption means encrypt at least the rebate total to produce encrypted data in base-12 format.

24. The system of claim 9, wherein the means for generating the identifier code is further arranged to generate a price pad associated with the identifier code, the price pad being stored at the same times as the identifier code, the encryption means being further arranged to use the price pad to encrypt the rebate total and the validation and decryption means being further arranged to use the price pad to decrypt the second code.

25. The system of claim 24 wherein the price pad is formed of a first number of characters in a first base format, the first number and first base format being identical to a second number and a second base format of the rebate total, wherein the encryption means is arranged to encrypt the rebate total by operating on characters of the rebate total with respective characters of the price pad in a predetermined manner.

26. The system of claim 9, wherein the rebate application means is arranged to authorise the rebate only if i) the received code is syntactically valid, ii) the live code is recognised by the validation and decryption means, and iii) the rebate total derived from the received code is reconciled with reconciliation information subsequently received by the validation and decryption means.

27. The system of claim 1, wherein the encryption means is further arranged to encrypt at least the rebate total to produce encrypted data in base-12 format.

28. The method of claim 23, in which the encryption means generate the rebate code on the basis of at least the identifier code and the rebate total.

29. The method of claim 23, wherein a price pad associated with the identifier code is generated and stored at the same times as the identifier code and the price pad is used to encrypt the rebate total and subsequently to decrypt the received code.

30. The method of claim 23, wherein the rebate is authorised only if i) the received code is syntactically valid, ii) the identifier code is recognised by the validation and decryption means, and iii) the rebate total derived from the received code is reconciled with reconciliation information subsequently received by the validation and decryption means.
